(19) United States
(12) Patent Application Publication
(10) Pub. No.: US 2021/0244040 A1
(43) Pub. Date: Aug. 12, 2021

(54) PROCESS FOR MAKING A DAIRY BEVERAGE WITH IMPROVED NUTRITION

(71) Applicant: Maple Hill Creamery, LLC, Glenview, IL (US)

(72) Inventors: Gary Smith, Glenview, IL (US); Alex Smith, Glenview, IL (US); Nigel Kirtley, Glencoe, IL (US)

(21) Appl. No.: 17/172,665

(22) Filed: Feb. 10, 2021

Related U.S. Application Data
(60) Provisional application No. 62/972,793, filed on Feb. 11, 2020.

(51) Int. Cl. A23C 9/142; A23C 9/13; A23C 9/16; A23C 9/12; A23C 9/137; A23L 2/52; A23G 9/40; A23C 3/03

(52) U.S. Cl. CPC A23C 9/1422; A23C 9/1307; A23C 9/1322; A23C 9/16; A23C 9/1206; A23C 9/137; A23V 2002/00; A23L 2/52; A23G 9/40; A23C 3/03; A23C 2210/202; A23C 2210/206; A23C 9/1315

(57) ABSTRACT

Embodiments of the invention as described herein relate to reduced sugar dairy products, and compositions including such products, which can offer the nutritional benefits of dairy consumption without the consumption of sugar, and methods for producing the same. Some embodiments relate to reduced protein, reduced sugar dairy products or high protein, reduced sugar dairy products, either with or without one or more mineral salt to modify perceived mouthfeel. In some embodiments, the reduced sugar dairy products can include beverages, concentrates, or powders. Further embodiments relate to methods for producing reduced sugar dairy products.

### CROSS REFERENCE TO RELATED APPLICATION

The present application claims the benefit of priority under 35 U.S.C. § 119(e) to U.S. Provisional Application No. 62/972,793, PROCESS FOR MAKING A DAIRY BEVERAGE WITH IMPROVED NUTRITION, filed on Feb. 11, 2020, which is currently co-pending herewith and which is incorporated by reference in its entirety.

### FIELD OF THE INVENTION

The invention disclosed herein generally relates to dairy products, and in particular dairy products with improved nutritional profiles.

### BACKGROUND

Conventional bovine milk has an average composition of 2.9-5.0% protein, 3.6-5.5% lactose, 2.5-6.0% fat, and 0.6-0.9% minerals, with the remainder being water (see, e.g., Alfa-Laval Dairy Handbook). It is typical that raw milk from the farm is standardized to ensure a consistent product for the consumer; therefore, conventional pasteurized retail whole milk has a typical composition of 3.2% protein, 5.1% lactose. 3.3% fat and 0.7% minerals (ash), with the remainder being water (see, e.g., USDA National Nutrient Database for Standard Reference legacy April 2018).

The lactose sugar in milk is a dimer comprising one unit of galactose and one unit of glucose. A significant proportion of the world population (some estimates are as high as 65%) are lactose intolerant, meaning that they are deficient in the lactase enzyme needed to breakdown lactose into galactose and glucose. Consequently, the lactose is not absorbed and continues into the lower gut where it can be metabolized by the gut micro-flora. This may result in discomfort and even diarrhea. It is possible to add a lactase enzyme (made commercially usually through a yeast or mold fermentation) to milk during processing so that the lactose is broken down in situ, producing a so called “lactose-free” milk which is sold commercially in various forms. In typical dairy processing, the lactase enzyme is added to the incoming-milk tank and held until the lactose is converted.

For regulatory and food safety reasons, lactase is added at refrigerated temperatures and can take 24 hours or longer. This results in in-coming raw milk tanks having to be segregated and silos taken out of the normal production cycle. Once the lactose is essentially fully converted, the milk is then heat treated to pasteurize (or ultra-pasteurize or sterilize) it according to food safety regulations and to extend shelf life. The heat treatment also deactivates the lactase enzyme, which may be a regulatory requirement in some regions. It is also possible to add a pre-sterilized form of lactase to the milk post-pasteurization (or ultra-pasteurization, sterilization), and such systems are offered (e.g. Tetra-Pak Aseptic Dosing Unit E). However, aside from the complication of addition under sterile conditions, this also means the lactase enzyme is still active in the packaged product, which may therefore need to be labelled differently.

In such processes, the lactose has not been removed, but rather simply converted into different sugars; the total sugar content of the milk has not changed. Lactose has a relatively low sweetness index of 0.2 (1.0 reference for sucrose) vs 0.6 and 0.5 for glucose and galactose, respectively. Consequently, by converting one molecule of lactose into one molecule of galactose and one molecule of glucose, the lactose-free milk can be perceived as sweeter, which some consumers may not prefer. Furthermore, nutritionists and public health bodies discourage the consumption of simple sugars, and especially sugar forms such as glucose, due to the increased risk of obesity and lifestyle diseases associated with sugar consumption, such as type II diabetes (see, e.g., 2015-2020 US Dietary Guidelines).

Although nutritionally lactose contributes to simple sugar consumption, it does not deliver the sweet taste that many consumers desire from sugar containing products due to its low sweetness index. For example, a 240 ml serving of milk contains approximately 12 g of lactose, which amounts to more than two teaspoonfuls of dry sugar. Interestingly, the US dietary guidelines have consistently encouraged increased consumption of “nutrient dense” dairy products, especially fat-free or low fat forms, whilst simultaneously discouraging consumption of simple sugars. A dairy product that would offer the nutritional benefits of dairy consumption without the consumption of sugar would therefore be advantageous.

Flavored milk drinks such as chocolate milk are popular and can be perceived as a way to encourage milk consumption by children. However, such products are usually formulated with added sugar (sucrose) to balance the flavor of the cocoa, thus making them sweeter and increasing their appeal. Total (i.e., lactose plus added sugars) sugar levels for chocolate milk typically lie in the range of 21 g to 27 g per 240 ml serving, which is comparable to a regular soda. Accordingly, even when these products are offered in a low-fat form, they still have significant calories and high levels of sugar. In some regions, the use of non-nutritive sweeteners is not sanctioned in milk, including flavored milks (see, e.g., U.S. Code of Federal Regulations 21 CFR 131.110), so the options to reduce total sugar and deliver an acceptable product are limited.

Since 2012, a number of concentrated dairy fluid products have been introduced into the U.S. market, which claim 50% higher protein levels and 50% less lactose (or sugar) than in conventional milk. To achieve this change in milk component ratios, the milk is subjected to a process called ultra-filtration, and the products are characterized as “ultra-filtered milk” in the marketplace. Ultra-filtration is a process where milk under pressure is passed across a filter with a defined pore-size so that a proportion of the water along with some of the smaller molecular components of milk pass through the filter membrane (permeate); the remaining milk material (retentate) has less water, and is therefore proportionally higher in protein (which is too large to pass through the filter membrane). Following the filtration, the protein level of the retentate is therefore higher, and the lactose level is reduced, as some lactose follows the water phase in the permeate. The protein thus can be selectively concentrated vs the lactose and other smaller molecules, and these products claim increased protein and reduced sugar (or lactose).

However, as lactose is distributed evenly in the water phase, it is impossible with ultra-filtration alone to remove all the lactose, as some of the water phase (and therefore lactose) must remain in the retentate. Accordingly, there is a practical limit to the amount of water that can be removed from the retentate and therefore the amount of lactose that can be removed using ultra-filtration. Consequently, some ultra-filtered milks use lactase to convert any remaining lactose in order to make a lactose-free claim for the product, in addition to claiming reduced sugar and increased protein. From a caloric point of view, protein and sugars both deliver the same number of calories per gram (4 calories/g). Given that protein deficiency in the U.S. and most other developed countries, remains rare, it is questionable as to whether simply changing the protein/sugar ratio has any real public health nutrition benefit. In addition, as the lactose has now been converted to equal parts of galactose and glucose by the lactase, there are some concerns related to blood insulin levels following consumption of a direct source of glucose.

Ultra-filtration is a common and well understood process in the modern dairy industry, being used mainly as a preliminary step to concentrate milk prior to spray drying, cheese production, or other further processing steps, as well as for recovery of by-product streams, such as whey. It is reasonable to assume that most consumers in developed markets are already exposed to food products produced with the benefit of ultra-filtration processing.

In view of the foregoing, a need exists for an improved diary-based product, such as a beverage, with a low or zero sugar level and a method for producing such a product as naturally as possible, in an effort to overcome the aforementioned obstacles and deficiencies of conventional milk and ultra-filtered milk products.

### SUMMARY OF THE INVENTION

Embodiments of the invention relate to reduced sugar dairy products with an improved mouthfeel, including dairy protein in an amount of 0.1%-12%; sugar in an amount of less than 5.0%; and minerals in an amount of 20 mg to 400 mg, or greater per 100 g of the reduced sugar dairy product; butter fat in an amount of 0%-36%; and wherein the reduced sugar dairy product is derived from milk.

In some embodiments, the reduced sugar dairy product includes dairy protein in an amount of 0.1%-12%; sugar in an amount of less than 1.2%; potassium in an amount of range 20%-400%; and butter fat in an amount of 0%-36%.

In some embodiments, the reduced sugar dairy product can be a beverage, a concentrate, or a powder. In some embodiments, the reduced sugar dairy product can include lactose in an amount of less than 5.0%. In some embodiments, the reduced sugar dairy product can be a beverage having less than about 5.0 g, 4.0 g, 3.0 g, 2.0 g, 1.0 g, 0.9 g, 0.8 g, 0.7 g, 0.6 g, 0.5 g, 0.4 g, 0.3 g, 0.2 g, 0.1 g, 0.09 g, 0.08 g, 0.07 g, 0.06 g, 0.05 g, 0.04 g, 0.03 g, 0.02 g, 0.01 g of sugar in an 240 ml serving. In some embodiments, the reduced sugar dairy product can be a beverage having about or below about 5.0%, 4.0%, 3.0%, 2.0%, 1.0%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01% w/w sugar. In some embodiments, the reduced sugar dairy product can have an increased or reduced protein level relative to that of untreated milk. the reduced sugar dairy product can have an increased protein level of greater than or equal to about 3.0%, 3.5%, 4.0%, 4.5%, 5%, 5.5%, 6.0%, 6.5%, 7.0%, 7.5%, 8.0%, 8.5%, 9.0%, 9.5%, 10.0%, 11.0%, or 12.0% w/w. In some embodiments, the reduced sugar dairy product can have a reduced protein level of less than or equal to about 3.0%, 2.5%, 2.0%, 1.5%, 1.0%, 0.5%, 0.4%, 0.3%, 0.2%, 0.1%, 0.05% w/w. In some embodiments, the reduced sugar dairy product can include a lactase enzyme.

In some embodiments, the reduced sugar dairy product can include one or more mineral salts. In some embodiments, the reduced sugar dairy product can include one or more potassium salts. In some embodiments, can include one or more potassium salts at a level of greater than or equal to about 20 mg, 25 mg, 50 mg, 75 mg, 100 mg, 125 mg, 150 mg, 175 mg, 200 mg, 225 mg, 250 mg, 275 mg, 300 mg, 325 mg, 350 mg, 375 mg, 400 mg, or greater of potassium per 100 g of the reduced sugar dairy product. In some embodiments, the potassium salt can include potassium chloride. In some embodiments, the potassium salt can include dipotassium phosphate, monopotassium phosphate, and/or tripotassium phosphate. In some embodiments, the potassium salt can include two or more of potassium chloride, dipotassium phosphate, monopotassium phosphate, and/or tripotassium phosphate. In some embodiments, the reduced sugar dairy product can include one or more additional alkali metal or alkali earth metal salts. In some embodiments, the reduced sugar dairy product can include one or more sodium, lithium, calcium, and/or magnesium salts. In some embodiments, the reduced sugar dairy product can include potassium chloride and sodium chloride.

In some embodiments, the reduced sugar dairy product can include one or more bitter blockers. In some embodiments, the reduced sugar dairy product can be a beverage and can have a fat level of than or equal to about 0.0%, 0.1%, 0.2%, 0.3%, 0.4%, 0.5%, 1.0%, 1.5%, 2.0%, 2.5%, 3.0%, 3.5%, 4.0%, 4.5%, 5%, or greater.

In some embodiments, the reduced sugar dairy product can include one or more thickening agent. In some embodiments, the thickening agent can include gellan gum. In some embodiments, the gellan gum can be at a level of about 0.01%-0.10%. In some embodiments, the reduced sugar dairy product can include potassium chloride, sodium chloride, and gellan gum.

In some embodiments, the reduced sugar dairy product can include potassium chloride at a level of 20%-200% of potassium levels in retail fat reduced milk, sodium chloride at a level of 10%-200% of sodium levels in retail fat reduced milk, and 0.01-0.10% gellan gum.

In some embodiments, the reduced sugar dairy product can include one or more fats and/or alternative fats. In some embodiments, the fat can include cream and/or the alternative fat can include canola oil, palm oil, coconut oil, and/or medium chain triglycerides (MCT).

In some embodiments, the reduced sugar dairy product can have the protein level of untreated bovine milk. In some embodiments, the reduced sugar dairy product can include 2.9%-5.0% protein, 3.6%-5.5% lactose, 2.5%-6.0% fat, and 0.6%-0.9% minerals. In some embodiments, the reduced sugar dairy product can have the protein level of conventional pasteurized retail milk. In some embodiments, the reduced sugar dairy product can include 2.9%-3.5% protein, 3.6%-5.5% lactose, 2.5%-6.0% fat, and 0.6%-0.9% minerals. In some embodiments, the reduced sugar dairy product can have the protein level of conventional pasteurized retail skim milk. In some embodiments, the reduced sugar dairy product can include 3.2%-3.5% protein, 3.6%-5.5% lactose, 0%-3.0% fat, and 0.6%-0.9% minerals.

In some embodiments, the reduced sugar dairy product can include less than 0.5 mg, 1 mg, 5 mg, 10 mg, 15 mg, 20 mg, 25 mg, 30 mg, or greater, sodium per 100 g.

In some embodiments, the reduced sugar dairy product can be pasteurized, ultra-pasteurized, and/or sterilized. In some embodiments, the reduced sugar dairy product the product can have a shelf life of greater than 14 days, greater than 28 days, greater than 1 month, greater than 2 months, or greater than 3 months. In some embodiments, the reduced sugar dairy product can be a reduced sugar whole milk beverage, a reduced sugar and reduced fat milk beverage, or a reduced sugar skim milk beverage.

In some embodiments, the reduced sugar dairy product can include one or more non-nutritive sweetener. In some embodiments, the non-nutritive sweetener can include one or more of stevia, monk fruit, D-allulose, acesulfame potassium, sucralose, erythritol, xylitol, sorbitol, lactitol, aspartame, saccharin, cyclamate, neotame, and/or advantame.

In some embodiments, the reduced sugar dairy product can include a natural or artificial flavoring, to provide a flavored dairy beverage. In some embodiments, the natural or artificial flavoring can include a coffee, cocoa, chai, berry, vanilla, coconut, and/or banana flavoring. In some embodiments, the reduced sugar dairy product can be a chocolate milk beverage.

In some embodiments, the reduced sugar dairy product can be derived from cow, sheep, goat, buffalo, or camel milk. In some embodiments, the reduced sugar dairy product can be derived from cow milk.

In some embodiments, the reduced sugar dairy product can be a powder comprising potassium in a level of about 20 mg-400 mg 100 g of the sugar-free (or low-sugar) dairy.

Further embodiments of the invention relate to compositions including the reduced sugar dairy product as described above and another food or beverage component. In some embodiments, the composition can be a sports drink or a coffee- or tea-based beverage. In some embodiments, the composition can be a dairy dessert, such as an ice cream.

Further embodiments of the invention relate to methods for providing a reduced sugar dairy product, the method including: a. pumping a first volume of a dairy product from a first filtration tank through a first ultra-filtration unit into a collection tank, to provide a first retentate and a first permeate; b. providing the first retentate to a subsequent filtration tank, which is the same or different from the first filtration tank; c. adding a volume of water into the subsequent filtration tank containing the first retentate, to reach a second volume in the subsequent filtration tank; d. pumping the second volume, comprising the first retentate and water, from the subsequent filtration tank through a subsequent ultra-filtration unit, which is the same or different from the first ultra-filtration unit, to provide a subsequent retentate and a subsequent permeate; and e. repeating steps of returning retentate to a subsequent filtration tank, which is the same or different from any previous filtration tank, adding water to reach a volume in the subsequent filtration tank, and pumping the volume through a subsequent ultra-filtration unit, which is the same or different from any previous ultra-filtration unit, to provide a new retentate and a new permeate, n times, where n can be an integer between 0 and 30, wherein the new retentate provides a reduced sugar dairy product; and wherein the method can remove at least 25% of the sugar present in the dairy product.

Further embodiments of the invention relate to a method for providing a reduced sugar dairy product, the method including: a. pumping a first volume of a dairy product from a first filtration tank through a first ultra-filtration unit, to provide a first retentate and a first permeate; b. injecting a volume of water to provide a diluted retentate; c. pumping the diluted rententate through a subsequent ultra-filtration unit, which is the same or different from the first ultra-filtration unit, to provide a subsequent retentate and a subsequent permeate; and e. repeating steps of injecting a volume of water to provide a diluted retentate, and pumping the diluted retentate through a subsequent ultra-filtration unit, which is the same or different from any previous ultra-filtration unit, to provide a new retentate and a new permeate, n times, where n can be an integer between 0 and 30, wherein the new retentate comprises a reduced sugar dairy product; and wherein the method can remove at least 25% of the sugar present in the dairy product.

In some embodiments, the method can remove at least 50%, 80%, 85%, 90%, 91%, 92%, 93%, 94%, 95%, 96%, 97%, 98%, 99%, or greater of the sugar present in the dairy product.

In some embodiments of the methods, the dairy product can be raw or pasteurized prior to undergoing any ultra-filtration step. In some embodiments, the volume of water added can be sufficient to bring the volume of the any filtration tank prior to any ultra-filtration step to that of the first volume of raw dairy product. In some embodiments, a lactase enzyme can be added to the dairy product prior to any ultra-filtration step. In some embodiments, the process can be a continuous process.

In some embodiments of the methods, a mineral salt and/or a naturally occurring salt can be added after obtaining a new retentate. In some embodiments, the mineral salt can include one or more potassium salts at a level of greater than or equal to about 20 mg, 25 mg, 50 mg, 75 mg, 100 mg, 125 mg, 150 mg, 175 mg, 200 mg, 225 mg, 250 mg, 275 mg, 300 mg, 325 mg, 350 mg, 375 mg, 400 mg, or greater of potassium per 100 g of the reduced sugar dairy product. In some embodiments, the potassium salt can include potassium chloride. In some embodiments, the potassium salt can include dipotassium phosphate, monopotassium phosphate, and/or tripotassium phosphate. In some embodiments, the potassium salt can include two or more of potassium chloride, dipotassium phosphate, monopotassium phosphate, and/or tripotassium phosphate. In some embodiments, the reduced sugar dairy product can include one or more additional alkali metal or alkali earth metal salts. In some embodiments, the reduced sugar dairy product can include one or more sodium, lithium, calcium, and/or magnesium salts. In some embodiments, the reduced sugar dairy product can include potassium chloride and sodium chloride.

In some embodiments, one or more thickening agent can be added after obtaining a new retentate. In some embodiments, the thickening agent can include gellan gum.

In some embodiments of the methods, one or more fats and/or alternative fats can be added before, during, or after any method step. In some embodiments, the fat can include cream and/or anhydrous milk fat and/or the alternative fat can include canola oil, palm oil, coconut oil, or medium chain triglyceride (MCT).

In some embodiments of the methods, the reduced sugar dairy product can have the protein level of untreated bovine milk. In some embodiments of the methods, the reduced sugar dairy product can have the protein level of conventional pasteurized retail milk. In some embodiments of the methods, the reduced sugar dairy product can have the protein level of conventional pasteurized retail skim milk.

In some embodiments, the methods further include heat treatment and/or high pressure processing (HPP) after obtaining a new retentate. In some embodiments, the heat treatment and/or HPP can be used to pasteurize, ultra-pasteurize, or sterilize the product. In some embodiments, the heat treatment can be conducted at a temperature between about 63-100 C. In some embodiments, one or more potassium and/or sodium salt can be added, and the heat treatment can be conducted at a temperature between about 63-150 C.

In some embodiments of the methods, the dairy product can be subject to one or more pre-processing steps. In some embodiments, the pre-processing steps can include pasteurization and/or standardization.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1 depicts the outline of an exemplary process in accordance with one embodiment where milk is pumped from a tank (vessel 1) through an ultra-filtration unit. In the ultra-filtration unit, components in the milk stream are separated according to their size so that large molecules (e.g., proteins) are retained, while some of the smaller molecules, such as lactose and some minerals, flow with water across the membrane. The retained stream (retentate) is thereby concentrated and returned to vessel 1. The pressure difference across the membrane and therefore the flow ratio between retentate and permeate can be controlled by adjusting the back pressure of the retentate stream (back-pressure valve 4). As the return retentate stream is concentrated, the volume (volume 3) in the feed tank (vessel 1) would, barring any other action, reduce. This produces what has been described as “ultra-filtered milk”.

FIG. 2 depicts a continuous process where some of the circulating feed is bled off as a product stream and replaced with fresh milk, whilst the permeate lost is continually replaced with water to constant volume.

FIG. 3 depicts results from sensory evaluation with milk consumers, where consumers showed a marked preference for the reduced sugar dairy product with mineral addition. Consumers also rated the low sugar 2% milk with mineral addition as parity in overall liking compared to standard 2% milk.

FIG. 4 depicts the results from a blind tasting of reduced sugar dairy products with and without added minerals by dairy consumers (n=109) in a Central Location Test carried out over 2 days in the greater Chicago area; the results clearly show that the added mineral combination improves the consumer acceptance of the low-sugar dairy product. Consumer test results, n=109, 9-point scale, differences significant at 95% confidence.

### DETAILED DESCRIPTION OF THE INVENTION

Unless otherwise noted, terms are to be understood according to conventional usage by those of ordinary skill in the relevant art.

As used herein, the terms “sugar-free”, “low sugar”, and/or “reduced sugar” encompass dairy products which have a lower level of sugar(s) than are found in dairy products prior to processing. For example, in some embodiments, the “sugar-free” and/or “reduced sugar” dairy products as described herein can have a total sugar concentration of <0.5 g per 240 ml serving. Further, in some embodiments, the “sugar-free” and/or “reduced sugar” dairy products as described herein can support a “sugar-free” assertion in the United States and/or in additional countries or jurisdictions. The levels for such assertions are set by regulatory authorities in the jurisdiction of interest, such as, for example, the U.S., European Union, Australia, New Zealand, Canada, Mexico, Brazil, Argentina, India, etc. One skilled in the art can determine the levels for such assertions. For example, in the U.S., the term “sugar-free” can indicate <0.5 g per 240 ml serving, “reduced sugar” can indicate 25% less sugar than the reference product (e.g. for milk assuming 12 g of sugar per serving in regular milk, “reduced sugar” can indicate <9 g per 240 ml serving).

As used herein, the term “milk” relates to a dairy product from an animal. In some embodiments, the animal can be a mammal. In some embodiments, the animal can be a human, cow, goat, sheep, buffalo, camel, and the like. One skilled in the art will appreciate which animals can produce milk products which can be used in accordance with the present invention.

As used herein, the terms “untreated milk” and/or “raw milk” relate to milk in its original form which has not been treated or otherwise processed. In some embodiments, “untreated milk” and/or “raw milk” may or may not be pasteurized.

As used herein, the term “mouthfeel” relates to how a consumer perceives the feel of a product in the mouth. In some embodiments, mouthfeel can enhance or detract from, or can be a distinction from taste or flavor. In some embodiments, mouthfeel can relate to the physical behaviour of the product on the tongue and/or how chemical receptors on the tongue trigger a perception of textural attributes. In some embodiments, the interaction of one or more component, such as a mineral component, of a reduced sugar dairy product in accordance with the invention described herein, with receptors on the tongue can change how a consumer perceives the texture of the product. In some embodiments, mouthfeel can encompasses one ore more sensory attributes related to the perception of the physical behaviour of the product in the mouth, such as, for example, smoothness, thickness, level mouth coating, creaminess, level of mouth drying, and the like, as would be appreciated by one skilled in the art. For example, smoothness is a measure of how smooth the product feels in the mouth and can be rated from slightly smooth to very smooth, where a slightly smooth product is chalky or powdery, and a very smooth product is easy to swallow. Thickness is a measure of the viscosity, from thin (similar thickness to water) to thick (similar to full fat milk). Mouth coating is a measure of the amount of coating or layer of film remaining in the mouth or on the tongue and/or lips, on a scale from a little to a lot of mouth coating. Creaminess relates to the intensity of creaminess in the mouth, on a scale from slightly to very creamy, the latter being similar to gelato. Mouth drying is a measure of the level of drying in the mouth, on a scale from a little to a lot of mouth drying. The drying sensation is reminiscent of eating peanuts. In some embodiments, an “improved” mouthfeel can relate to increased levels of mouthfeel. For example, an improved mouthfeel can relate to an increased level of one or more measures of mouthfeel, such as, for example, one or more of smoothness, thickness, level mouth coating, creaminess, level of mouth drying, and the like.

Embodiments of the invention as described herein relate to dairy products which can offer the nutritional benefits of dairy consumption without the consumption of sugar, and methods for producing the same.

As described herein, a reduced-protein, sugar-free (or low-sugar) dairy beverage, either with or without a soluble potassium salt, such as potassium chloride, (or other mineral salt) addition to modify perceived mouthfeel, can be produced which can be positioned as a positive, natural thirst quencher. In some such embodiments, the dairy protein level can be in the range of 0.05 to 10% (w/w).

As described herein, a high-protein, sugar-free (or low-sugar) dairy-based beverage can be produced and positioned as a nutritious low carbohydrate beverage. With the addition of a soluble potassium salt, such as potassium chloride, the body mouthfeel can be improved in some examples without the need for thickening ingredients, such as gellan gum, guar gum, modified starch, and the like, which can be optionally added. As described herein, it is has been found that levels of gellan gum above 0.015% also can improve shelf life stability of ultra-pasteurized products. In some such embodiments, the dairy protein level can be in the range of 3% to 9% (w/w).

In some embodiments, the “sugar-free” (low-sugar) dairy-based beverage can be used as a base material for a flavored dairy beverage (e.g., chocolate milk). In various examples, conventional sugars or non-nutritive sweeteners can be added in essence to fully or partially replace the original, less sweet lactose so as to deliver a sweet product but at significantly lower total sugar content as compared to conventional flavored milk products (which can contain the original lactose as well as the added conventional sugar or non-nutritive sweeteners). In some such embodiments, a soluble potassium salt, such as potassium chloride, and/or other mineral salts can be added to increase body mouthfeel.

Various exemplary embodiments as described herein relate to a dairy-based beverage; however, milk is widely consumed in a number of ways outside of as a beverage (e.g., with tea or brewed coffee, as a milk foam in coffee drinks, such as cappuccinos and lattes, with breakfast cereal, etc.). Accordingly, a sugar-free (or low-sugar) dairy-based product can be considered as a broader substitute for milk across all its forms of consumption, so the present disclosure should not construed as limiting.

### Ultra-Filtration

In ultra-filtration (UF) processes, colloidal and high-molecular particles are concentrated by means of a pressure drop across a semi-permeable membrane. Smaller molecules, such as water, salts and sugar, pass through the membrane whilst larger molecules such as protein are retained on the original side and are thereby concentrated. After UF, the portion of liquid that does not pass through the membrane and contains the high-molecular particles is referred to as the retentate, whilst the portion of liquid passing through the membrane with the smaller molecules is referred to as the permeate. The membrane is semi-permeable due to the presence of small, consistent pores which typically have a size of between 0.001 to 0.1 μm, depending on the duty (reference: Dairy Processing Handbook 2015 Tetra Pak Processing Systems AB). The pressure to drive the permeate fraction through the membrane is supplied by pump pressure on the product inlet side of the membrane unit.

Commercial dairy UF systems are designed to run in a cross-flow mode where the fluid is pumped over the surface of the membrane so that the flow of material across the membrane (permeate) is perpendicular to the flow of the retentate. The simplest arrangement is for the membrane to be formed into a hollow tube, and the feed material is pumped through the centre and any permeate leaves across the membrane perpendicular to the flow and is collected on the other side. With this cross-flow arrangement, the material at the surface of the membrane can be continuously renewed.

However, this renewal effect depends on the flow conditions at the surface of the membrane. Further, because the retentate becomes more concentrated as it travels along the membrane surface, the rheology changes and the ability to constantly renew material at the surface declines. In practice there is always some build-up of retenatate material on the inner membrane surface (blinding), which over time reduces the flow of permeate across the membrane at a given trans-membrane pressure. This means that UF systems must at some point be stopped and cleaned to remove the accumulation of retentate materials at the active membrane surface.

In general, higher pressures are required for higher throughputs, higher product viscosities, and smaller pore sizes. However, there are practical limits to the operating pressures due to considerations such as the mechanical strength of the membranes and cost of the associated valves and piping, and operating pressures are generally in the range of 1-10 bar (reference: Dairy Processing Handbook 2015 Tetra Pak Processing Systems AB). A number of companies offer different materials and configurations of membranes for use across a wide variety of industries, in addition to dairy.

In the dairy industry, specific demands are placed on the membrane namely: high permeate flow, relatively high molecular selectivity (i.e. size), resistance to chemicals used in clean-in-place processes, service life, and cost. In the dairy industry, the most important design characteristic is generally the flow rate across the membrane, i.e. the permeate flow rate per area of membrane, as this decides the capacity of the unit and capital cost. This flowrate is determined by the resistance to flow across the membrane as a result of two barriers. Firstly, the resistance to flow of the membrane alone which is a function of the membrane thickness, the pore size, and the fraction of pore surface area to total membrane surface. Secondly, by the resistance to flow as a result of a concentration gradient created at the active membrane surface; as the permeate flows through the membrane, the retentate material creates a layer on the membrane surface, effectively resulting in a secondary barrier. Three factors drive the degree of formation of this secondary barrier, namely: the flow velocity of the retentate perpendicular to the membrane (the renewal effect), the length of the membrane and the concentration of the retentate and therefore its rheology. As the concentration of the retentate material increases then the thicker this secondary barrier. It is this secondary barrier which largely determines flowrate, separation ability and operation time between cleaning cycles. In effect, optimal operation of a UF unit is essentially a balance between degree of concentration, overall membrane surface, molecular size specificity, retentate viscosity, operating pressure, and the ratio of run time to cleaning cycle time.

UF systems can be run either as batch systems, where the retentate is constantly returned to the feed balance tank so that the overall concentration increases and the batch is complete when the desired concentration factor is achieved. Alternatively, and more commonly in modern commercial systems, the UF system is designed to run continuously with a number of UF sections arranged in series. In this arrangement, the retentate from the first UF section is pumped into the second UF section as the feed material. By arranging the appropriate number of sections in series it is possible to achieve the desired concentration factor in one pass and the unit run in a continuous rather than a batch mode.

The increase in the concentration on the retentate side is a limiting factor as to the effectiveness of a UF operation. It is however, possible to run a UF system where the concentration on the retentate side is held at a constant level by addition of fresh dilutant (typically water) to replace the lost permanent volume, this variant of UF is referred to as diafiltration. In essence, e diafiltration can be thought of as the opposite to the above described UF process in that the desired outcome is not concentration of the larger molecule in the retentate but rather the removal of the smaller accompanying molecules, e.g. lactose, in the retentate stream. As the concentration of the larger molecules is limited or avoided in diafiltration through addition of fresh dilutant, it stands to reason that the average flowrate across the membrane will generally be higher than for a UF unit where the retentate is concentrated. However, when it is desired to achieve a high degree of removal of the smaller molecules, it will be necessary to add several volumes of dilutant so as to rinse out the smaller molecules until the desired concentration is achieved. Consequently, although the average flowrate will therefore be higher, the amount of permeate to be removed across the membrane may be several factors more than in UF which rather concentrates the larger molecules. It is possible to design a UF system which combines both a diafiltration section to selectivity remove the smaller molecules followed by a concentration section where the larger molecules are concentrated in the retentate through removal of excess dilutant via the permeate stream. Such a system can be used prior to spray drying where it is desired to achieve a purified dairy protein concentrate (e.g. 95%+ dry weight basis) with few soluble minerals or sugar present.

Given the widespread adoption of UF in the food and beverage industry, most consumers in developed markets are likely already exposed to food products produced with the benefit of ultra-filtration processing.

In UF, the retentate concentration increases as smaller molecules pass through the membrane carried by water. There is a practical limit to the upper level of retentate concentration and therefore the number of small molecules that can pass across the membrane. UF can be used along with diafiltration, which is a process wherein some of the water lost in the permeate phase is replaced in the retentate so that the concentrating of the retentate is slowed or eliminated, thus allowing small molecules to continue to be transferred across the membrane and not limited by the practicalities of high retentate concentrations.

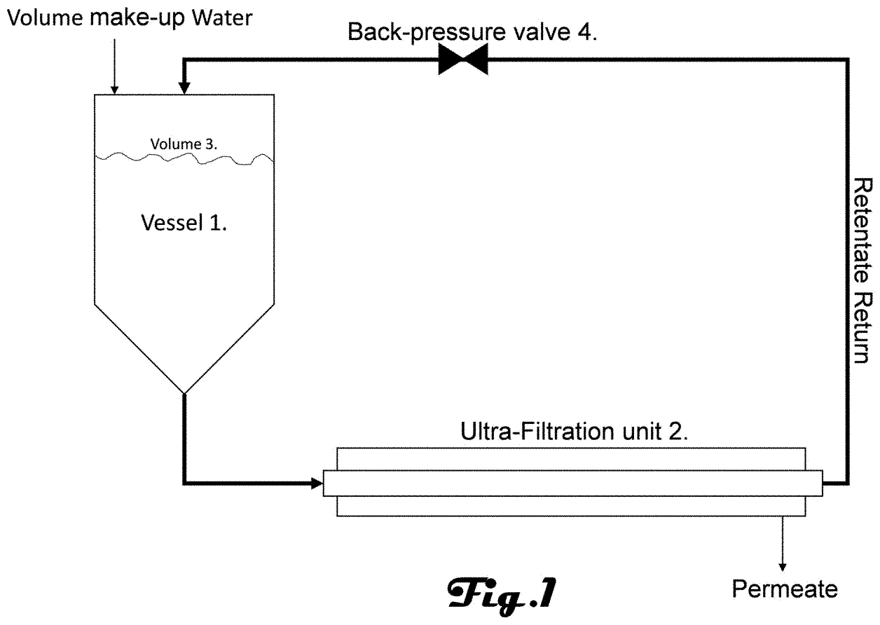

As described above, FIG. 1 shows the outline of an example process in accordance with one embodiment where milk is pumped from a tank through an ultra-filtration unit, which separates components in the milk stream according to their size; this process removes lactose, which flows along with water across the membrane. The retained stream (retentate) is thereby concentrated and returned to vessel 1. The pressure difference across the membrane and therefore the flow ratio between retentate and permeate can be controlled by adjusting the back pressure of the retentate stream (back-pressure valve 4). As the return retentate stream is concentrated, the volume (volume 3) in the feed tank (vessel 1) would, barring any other action, reduce.

In the exemplary process shown in FIG. 1 and described above, potable water is fed into the feed tank to replace the volume of fluid lost in the permeate stream (e.g., to ensure a constant volume level circulating in the system). This means that the concentration of the larger retained molecules (e.g., protein) remains constant, while the concentration of small molecules retained in the retentate is steadily diluted as the product feed continually cycles through the ultra-filtration unit. In some embodiments, water can be fed back into the feed tank to generate a generally constant, increasing or decreasing volume level circulating in the system, during some or all portions of the ultra-filtration process.

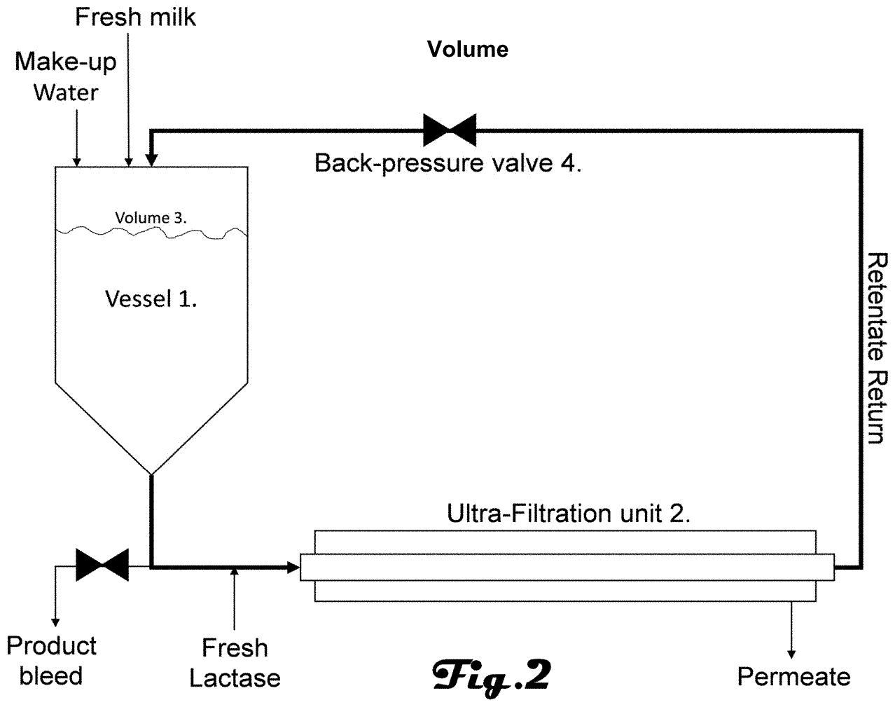

This can also be accomplished via a continuous process, as shown in FIG. 2. In this exemplary continuous process, some of the circulating feed is bled off as a product stream and replaced with fresh milk, whilst the permeate lost is continually replaced with water to constant volume.

Some embodiments can eliminate the role of the feed tank in the recycling of retentate and can instead have a closed loop system where the water addition is injected inline. Similarly, some embodiments can control the backpressure of the permeate outflow so as to change the ratio of retentate to permeate. Depending on the set-up of the ultra-filtration equipment and control system or other factors, in various examples, it can be advantageous in the initial stages of the process to delay adding water back to replace permeate, so the volume in the system declines but is then built back up to an original level at a later stage in the filtration process. There can be any number of suitable variations relating to equipment setup and process conditions, but the addition of make-up water to replace the lost permeate and retain a flow of water across the membrane so that lactose is essentially rinsed out into the permeate stream can be important in various embodiments.

### Reduced Sugar Milk Products

Using the exemplary processes described herein, such as those described in the preceding section, the concentration of sugar in the feed stream can be reduced to very low levels (e.g., less than or equal to 0.1% w/w) whilst maintaining the concentration of protein and fat essentially unchanged from the original milk. At 0.1% w/w sugar (around 95% sugar removal), the final product can have less than 0.5 g of sugar in a 240 ml serving; this sugar level can therefore support a “sugar-free” claim based on labeling requirements of some jurisdictions. Higher concentrations of sugar are also possible and can support a reduced-sugar/sugar-free claim based on labeling requirements of some jurisdictions.

In some embodiments, a product of such a process can have sugar removal of greater than or equal to 25%, 50%, 60%, 70%, 75%, 80%, 85%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, and the like, inclusive of any intermediate values. In some embodiments, a product of such a process can have a w/w sugar level of less than or equal to 10.0%, 9.0%, 8.0%, 7.0%, 6.0%, 5.0%, 4.0%, 3.0%, 2.0%, 1.0%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, and the like, inclusive of any intermediate values. In some embodiments, a product of such a process can have a level of sugar of less than or equal to 10.0 g, 9.0 g, 8.0 g, 7.0 g, 6.0 g, 5.0 g, 4.0 g, 3.0 g, 2.0 g, 1.0 g, 0.9 g, 0.8 g, 0.7 g, 0.6 g, 0.5 g, 0.4 g, 0.3 g, 0.2 g, 0.1 g, 0.09 g, 0.08 g, 0.07 g, 0.06 g, 0.05 g, 0.04 g, 0.03 g, 0.02 g, 0.01 g, and the like, inclusive of any intermediate values, in a 240 ml serving.

### Protein Content

In some embodiments involving the processes described herein, once the lactose is removed, the method can include shutting off the water feed and continuing processing through the ultra-filtration unit to produce a more concentrated dairy beverage with levels of protein in excess of 3.5% but still at reduced or minimal sugar levels. This can deliver a dairy product or beverage which has increased protein content (high protein) and is sugar-free (lactose-free). This can be useful when, for example, it is desired to ultra-filter the milk in one location and transfer to another location for reconstituting to a lower protein content and subsequent processing and filling. The concentration step therefore reduces the number of tankers required for transfer of the product.

In some embodiments, a high protein product of such a process can have levels of protein of greater than or equal to about 3.0%, 3.5%, 4.0%, 4.5%, 5.0%, 6.0%, 7.0%, 8.0%, 9.0%, 10.0%, 11.0%, 12.0%, and greater, and the like, inclusive of any intermediate values.

Alternatively, in further embodiments, the water-replacement feed can be increased rather than shut off to produce a dairy product or beverage which is more dilute and has reduced protein content (low protein) and is sugar-free (lactose-free).

In some embodiments, a low protein, sugar-free product of such a process can have levels of protein of less than or equal to about 3.0%, 2.5%, 2.0%, 1.5%, 1.0%, 0.5%, 0.4%, 0.3%, 0.2%, 0.1%, 0.05%, or less, and the like, inclusive of any intermediate values.

### Lactase Addition

Some embodiments in accordance with the methods described herein can include adding a lactase enzyme into the feed material. As previously described, lactase can break down the lactose dimer into galactose and glucose monosaccharides. Depending on the temperature, lactase concentration, and the overall processing time, it is possible to achieve almost a 100% conversion of lactose in various examples. The resulting galactose and glucose sugars can still be rinsed into the permeate stream, just like with lactose, but the overall process can be improved (e.g., to achieve reduction in time, energy, losses, effluent, etc.) depending on the membrane characteristics and other conditions. The lactase enzyme can be retained in the retentate stream and remains active in various embodiments. One skilled in the art would understand an appropriate quantity of lactase to be added, as well as the relevant temperature and processing conditions which can be used in such an embodiment.

Further embodiments can comprise a continuous process (e.g., as shown in FIG. 2) where some of the circulating feed is bled off as a product stream and replaced with fresh milk, whilst the permeate lost is continually replaced with water to constant volume. This can be done with or without lactase addition. In some embodiments wherein lactase is added, the process would circulate with active and retained lactase, converting much of the remaining circulating lactose to galactose and glucose. In this way, various embodiments can produce a reduced sugar, no sugar (low-sugar), and lactose-free dairy beverage. Given the cost of the lactase enzyme and the time (e.g., over 24 hours) needed in a tank to convert the lactose to galactose and glucose in some examples, this process can have a number of advantages.

### Mineral Addition

The sugar-free (low-sugar) dairy based material from diafiltration can be noticeably less sweet than the conventional milk used as the original source material, which can be expected in various embodiments given that lactose does impart some sweetness in milk. The sugar-free dairy-based beverage can also have a different mouthfeel, with less body. Interestingly, when sugar is added back to replace the removed lactose in some examples, the sweetness increases, as expected, but there is little noticeable change in the mouthfeel. The product still has a reduced body, even though, at constant volume, the protein and fat content can be the same for the sugar-free dairy beverage and the conventional milk used as the original source material.

As described herein, when a soluble potassium salt, such as potassium chloride, is added to the sugar-free (low sugar) dairy product or beverage, the mouthfeel changes, and there can be a noticeable increase in the perceived body. For example, an increase in the perceived body can be detected at a level in the range of, for example, 10% to 200% the potassium levels in conventional milk. The USDA National Nutrient Database for Standard Reference legacy April 2018 for whole milk without vitamins cites potassium levels to be 132 mg per 100 g and for skimmed milk at 156 mg potassium per 100 g, meaning the effective range for potassium addition can be from 26 mg to 320 mg potassium per 100 g of the sugar-free (or low-sugar) dairy base.

Accordingly, in some embodiments, a soluble potassium salt, such as potassium chloride, can be added in the range of greater than or equal to about 10% to 200%, 50% to 150%, 75% to 125%, or the like, of the potassium levels in conventional milk, such as 10%, 20%, 25%, 30%, 35%, 40%, 45%, 50%, 60%, 70%, 75% 80%, 90%, 100%, 110%, 120%, 125%, 130%, 140%, 150%, 160%, 170%, 180%, 190%, 200%, 250%, 300%, 350%, 400%, or greater, and the like, including any intermediate value. In some embodiments, a soluble potassium salt, such as potassium chloride, can be added in the range of greater than or equal to about 20 mg, 25 mg, 50 mg, 75 mg, 100 mg, 125 mg, 150 mg, 175 mg, 200 mg, 225 mg, 250 mg, 275 mg, 300 mg, 325 mg, 350 mg, 375 mg, 400 mg, or greater of potassium per 100 g of the sugar-free (or low-sugar) dairy base, and the like, including any intermediate value.

The improved mouthfeel upon addition of a soluble potassium salt, such as potassium chloride, is unexpected, and in some trial experiments using a soluble sodium salt, such as sodium chloride, in place of potassium chloride, the change in mouthfeel is less pronounced. However, in trial experiments where potassium chloride and sodium chloride are added together, the effect of increased body is again more apparent. Sodium can thus be added, in molar concentrations similar to that of potassium already indicated or another suitable amount, to the sugar-free (or low-sugar) dairy base, in order to modify mouthfeel.

There can be practical sensory limits to the amount of mineral salts that can be added. In the case of potassium, for example, some segments of the population are sensitive to potassium levels and perceive a bitter taste above a certain threshold. Accordingly, some embodiments can use so-called “bitter-blockers”, which can reduce or eliminate the bitter impact of potassium for those sensitive members of the population. Bitter blockers are described by, for example, “Masking Bitter Taste by Molecules” by Jakob Ley in Chem. Percept. (2008) 1:58-77, which lists various potassium bitter blockers, including thaumatin, ornithine derivatives, taurine and taurine/AMP, imidazole derivatives, L-aspartyl-L-phenylalanine potassium salts, lactisol, and the like. One skilled in the art would be able to determine further appropriate bitter blockers which could be used in accordance with the present invention. Likewise, if sodium chloride is also used, a salty taste can be created above a certain level, which may be undesirable for some products or users.

The optimal level of addition of the potassium salt in some embodiments can vary according to the level of impact on mouthfeel desired as well as the composition (e.g., fat and protein content) of the sugar-free (or low-sugar) dairy base. The range of effective potassium concentration in some embodiments generally can be between 20% and 200% of the level of potassium found in conventional milk, or from 26 mg to 320 mg potassium per 100 g of the sugar-free (or low-sugar) dairy base. With the described process and the range of potassium addition levels indicated herein, in various embodiments it is possible to achieve a desirable change in the perceived body mouthfeel without reaching the limits for creating off-tastes associated with the added cations.

The marked difference in mouthfeel between potassium chloride and sodium chloride indicates that, in some embodiments, the primary driver for the mouthfeel impact can be the metal cation. In one embodiment, other alkali metal (e.g., lithium) salts or mixtures thereof aside from or including sodium and/or potassium can be added, in molar concentrations similar to that of potassium already indicated or another suitable amount, to the sugar-free (or low-sugar) dairy base, in order to modify mouthfeel.

The property of modifying mouthfeel is not restricted to the alkali metal ions but can also extend to the alkali earth metal ions. In one embodiment, alkali earth metal (e.g., calcium, magnesium) salts are added either alone or mixtures thereof, in molar concentrations similar to that of potassium already indicated or in another suitable amount, to the sugar-free (or low-sugar) dairy base, in order to modify mouthfeel.

In some embodiments, it is not necessary to use either alkali metal salts or alkali earth metal salts. In other embodiments, mixtures of one or more alkali metals together and/or mixtures of one or more alkali earth metal salts are added, in molar concentrations similar to that of potassium already indicated or in another suitable amount, to the sugar-free (or low-sugar) dairy base, in order to modify mouthfeel.

In various embodiments, alkali metal salts or alkali earth salts that are used can be water soluble in order to achieve the required molar concentrations. Additionally, in various embodiments, it can be desirable for such salts to be suitable for food use in the indicated concentrations.

In further embodiments, other soluble sources of potassium aside from chloride can have a similar effect. For example, dipotassium phosphate was added to the sugar-free (or low-sugar) dairy base at a level to provide a final potassium level in the region of 60-65 mg/100 g in the product. It also produced a noticeable increase in perceived mouthfeel compared to the sugar-free (or low-sugar) dairy base without addition; however, the increased change in mouthfeel was not as pronounced as for potassium chloride at similar final potassium levels. However, in various examples, the chloride anion can also play a role, as can other forms of food suitable anions (e.g., sulphate, nitrate, and the like). In some embodiments, alternative anions to chloride, in similar molar concentrations as those already indicated for potassium chloride or another suitable amount, can be added in the form of salts to the sugar-free (or low-sugar) dairy base in order to modify mouthfeel.

Potassium chloride can be desirable because it is a common material used in the food industry in part to reduce sodium levels in processed foods. Some natural salts contain significant levels of potassium and other metal ions alongside the dominant sodium chloride. Accordingly, some embodiments can use a natural salt that has the appropriate potassium to sodium ratio for achieving the desired perceived body mouthfeel, making for a simpler, more consumer-friendly ingredient line. In some embodiments, a naturally occurring “salt” can be added, such as sea salt, Himalayan salt, black lava salt, bamboo salt, etc., and the like, or any other specific type of salt, including salts extracted from the sea or mined. Added salt can be in similar molar concentrations already indicated or another suitable amount to the sugar-free (or low-sugar) dairy base in order to modify mouthfeel. The ingredient line can then indicate “sea salt” or “Himalayan salt” etc., depending on the salt source. There are also mixtures of potassium chloride and sodium chloride (with other trace minerals) which are referred to as “low-sodium” salt that can also be used although the relative proportions of potassium and sodium have to be balanced to deliver improved mouthfeel whilst not too much salt taste.

From a nutrition perspective, much of the nutritional value of the milk, namely protein, fat and calcium can be retained in a sugar-free dairy beverage made with systems and methods described herein. Aside from calories, the lactose delivers little nutritional benefit in milk and indeed because of lactose intolerance may actually detract from it. Potassium is considered a positive nutrient and, although it is rinsed out of the retentate stream into the permeate along with the lactose, it can be added back in the form of potassium chloride (or other potassium salt) in the final product to provide more body in the mouthfeel as well as nutrient value. Aside from some minor minerals where milk consumption is not considered a significant dietary source, a sugar-free dairy beverage can retain much of the original nutritional goodness of milk. Unless sodium chloride (or other sodium salt) is added back, the product can also be very low in sodium, for example, sufficiently low in sodium to support a reduced sodium or low sodium assertion. Levels considered to be “low sodium” can vary by jurisdiction, but the U.S. defines these values by code in 21 C.F.R. 101.61. Specifically, a low sodium assertion for a dairy product where the serving size is 240 ml can be less than 140 mg sodium per serving, which is equivalent to about 57 mg/100 g. A reduced sodium assertion can require 25% less sodium than regular milk (e.g. 25% lower than 43 mg/100 g). Accordingly, in some embodiments, a low protein, sugar-free product have sodium levels of about or below 43 mg, 40 mg, 35 mg, 30 mg, 25 mg, 20 mg, 15 mg, 10, 5 mg, or less, per 100 g.

As described herein, combining a diafiltration process to remove essentially all the sugar content of the milk stream and then adding potassium chloride (or other soluble potassium salt) enables the production via various examples and methods to make a “sugar-free” (or low-sugar) dairy beverage with a body mouthfeel similar to that of conventional milk. This product can be made at various fat contents (e.g., 0-5%) and/or at various protein concentrations (e.g., 0.5-9%).

During processing, a proportion (typically 20-40% depending on conditions) of the calcium found in milk is lost from the sugar-free (or low-sugar) dairy base. As dairy products are recognized as an important source of calcium in the diet, it is desirable to restore the calcium levels to deliver an “excellent source” of calcium per serving, i.e. 260 mg/240 ml. This can be done with the inclusion of tricalcium phosphate, calcium carbonate, or other calcium mineral approved for food use into the mineral mix addition.

### Additional Processing Steps

In order to make a safe product with increased shelf-life, the resulting sugar-free dairy beverage in some embodiments can be heat-treated to pasteurize, ultra-pasteurize, or sterilize the product. This can be analogous with conventional milk processing. However, the sugar-free (or low-sugar) dairy beverage, lacking any significant source of reducing sugar in various examples, can be much less susceptible to Maillard and other chemical reactions, so the caramelized burnt notes often associated with heat treated dairy products, (e.g., UHT long shelf-life products) can be missing or reduced. Some examples can include pasteurizing the sugar-free (or low-sugar) dairy beverage not by heat but through high pressure processing (HPP), or any other suitable method for pasteurization, as would be appreciated by one skilled in the art.

Interestingly, it has been found that a sugar-free (or low-sugar) dairy base without any supplementary mineral addition can be sensitive to the degree of heat treatment used for pasteurization, ultra-pasteurization, or sterilization. While pasteurizing the sugar-free (or low-sugar) dairy base at temperatures between 63-100 C presented no problem, at higher temperatures (e.g. 139 C) using direct steam injection and post holding tube homogenization at 2000 psi resulted in an immediate formation of a fibrous protein precipitate which prevented any further processing. This appears to be independent from any pre-treatment of the incoming milk supply prior to the ultra-filtration/dialysis. That is, the incoming milk can be raw untreated, pasteurized or pasteurized and homogenized, but the same effect of protein precipitation occurs at higher heat treatment. However, if potassium chloride and sodium chloride or dipotassium phosphate and sodium chloride are added at levels of 59-65 mg/100 g and 35-40 mg/100 g for potassium and sodium respectively, then there is no protein precipitation during heat treatment at 139 C. In other words, the addition of a mix of potassium and sodium salts can improve the mouthfeel of the resulting sugar-free (or low-sugar) dairy base product and can also allow it to be processed at ultra-pasteurization temperatures. This is important because it can allow the product to be sold with extended shelf life beyond the typical 14 days for pasteurized products.

Depending on the location and arrangement of the ultra-filtration process, the starting milk used as the source material for the sugar-free (or low-sugar) dairy base can either be raw (i.e., untreated) or pre-processed in some way such as pasteurization or standardization to a specific fat and or dairy solids content. The starting milk used as source material can also be subjected to one or more pre-processing steps, such as, for example, homogenization, standardization, and/or a heat treatment, and the like, as would be appreciated by one skilled in the art. As noted earlier, this has not been seen to have an impact on the characteristics of the final product. The processed milk can also be subjected to one or more post-processing steps, such as, for example, aeration and/or foaming of the product, and/or gasification with carbon dioxide, and the like, as would be appreciated by one skilled in the art.

The sugar-free (or low-sugar) product resulting from diafiltration can be consumed directly as a “sugar-free” (low sugar, reduced sugar) dairy-based beverage, either with or without potassium chloride (or other potassium salt) addition to modify perceived mouthfeel.

### Other Additives

Interestingly, it was observed that although sugar-free (or low-sugar) dairy base with the supplementary addition of a potassium chloride and sodium chloride blend could be ultra-pasteurized, there are changes in the product during shelf life studies. When the ultra-pasteurized product is stored under refrigerated conditions in hermetically sealed containers, a soft gel material can start to form at the bottom of the container after a period of 7-21 days. Analysis of this material confirms that it is primarily composed of protein and fat. Initially the gel is soft and on shaking the container is easily re-disbursed back into solution. However, with increasing storage time, e.g. 30+ days, the gel becomes increasingly difficult to re-disperse into solution, and gel lumps were still apparent even after prolonged shaking. This gel formation was not observed if the supplementary mineral addition comprises a blend of dipotassium phosphate and sodium chloride or a blend of potassium chloride, dipotassium phosphate, and sodium chloride. Furthermore, it was found that the addition of a blend of potassium chloride, sodium chloride, and gellan gum (high acyl), which is a complex carbohydrate used as thickening agent in some food products, also prevented gel formation through shelf life (90 days+). This was not true when the gellan gum was added at a concentration of 0.015% but was true when the addition level of gellan gum was increased to 0.03%. Although gellan gum is a thickening agent, the change in viscosity is barely perceptible at these low levels.

Accordingly, in some embodiments, gellan gum can be added in the range of greater than or equal to about 0.01%-0.10%, such as 0.01%, 0.025%, 0.03%, 0.035%, 0.04%, 0.05%, 0.06%, 0.07%, 0.08%, 0.09%, 0.10%, or the like, including any intermediate value.

If another thickening agent is used, such as whole oat flour at concentrations of 0.2-0.35% then the formation of a gel is still seen within 21 days of storage. In other words, the effect of gellan gum in preventing gel formation is not common to all thickening agents. Table 1 below summarizes results from studies on various compositions.

TABLE 1
Impact of composition on gel formation during shelf life for ultra-
pasteurized sugar-free (low sugar) dairy beverage.

| | | | Gel |
|---|---|---|---|
| | Lactose | Potassium | formation |
| Composition | g/100 g | mg/100 g | seen after |
| Sugar Free Fat Reduced Milk | 0.16 | 61-62 | 7-21 days |
| with KCl/NaCl addition | | | |
| Sugar Free Fat Reduced Milk | 0.16 | 55 | 21 days |
| with KCl/NaCl and 0.015% | | | |
| Gellan Gum addition | | | |
| Sugar Free Fat Reduced Milk with | 0.16 | 50 | Not seen |
| KCl/NaCl and 0.03% Gellan Gum | | | after 90 |
| addition | | | days |
| Sugar Free Fat Reduced Milk with | 0.16 | 51 | 21 days |
| KCl/NaCl and Whole Oat Flour | | | |
| 0.2% addition | | | |
| Sugar Free Fat Reduced Milk with | 0.16 | 52 | 21 days |
| KCl/NaCl and Whole Oat Flour | | | |
| 0.35% addition | | | |
| Sugar Free Fat Reduced Milk with | <0.5 | 62 | Not seen |
| K₂HPO₄/NaCl addition | | | after 90 |
| | | | days |
| Sugar Free Fat Reduced Milk with | 0.14 | 59 | Not seen |
| KCl/K₂HPO₄/NaCl and 0.03% | | | after 90 |
| Gellan Gum addition | | | days |
| Sugar Free Whole Milk with | 0.19 | 60 | Not seen |
| KCl/K₂HPO₄/NaCl and 0.03% | | | after 90 |
| Gellan Gum addition | | | days |

The sugar-free (or low-sugar) product resulting from diafiltration can be consumed as a “sugar-free” (low-sugar) dairy-based beverage, either with or without potassium chloride (or other potassium salt) addition to modify perceived mouthfeel with the addition of a non-nutritive sweetener, to increase sweetness to something closer to the original milk. Non-nutritive sweeteners are known to those skilled in the art and include, for example, stevia, monk fruit, D-allulose, acesulfame potassium, sucralose, erythritol, xylitol, sorbitol, lactitol, aspartame, saccharin, cyclamate, neotame, advantame, and the like. In various examples, only low levels of non-nutritive sweetener can be required, as milk may not be particularly sweet, thus avoiding the off-flavors usually associated with intense non-nutritive sweeteners.

### Fat Content

The starting milk used as the source material for the sugar-free (or low-sugar) dairy base can be of varying fat content, including between 0% fat (skimmed milk) and 5% (farm whole milk), or the like. As the fat can be retained in the retentate, selecting the fat content of the source milk can be used to deliver a specific fat content in the resulting sugar-free (or low-sugar) dairy base. Alternative fats to butter fat (e.g., canola oil, palm oil, coconut oil, and/or medium chain triglycerides (MCT), and the like) can also be used in the initial source material. Alternative fats are known to those skilled in the art and include, for example, MCT, coconut oil, palm oil, sunflower oil, soy oil, and the like.

Carrying out the UF treatment of the milk already standardized at the desired fat content has an advantage that the sugar level can be driven extremely low (less than 0.1 g/100 g). However, running higher fat levels through a UF system may not be desirable in a production environment, as this may require a specific arrangement of filter membranes as well as reducing through put. An alternative is to ultra-filter the milk at a lower fat content than desired and then standardize the fat content of the resulting sugar-free (or low-sugar) dairy base as desired with the addition of dairy fat or cream. The disadvantage of this approach is that the cream component includes sugar as well as fat and protein, so as well as increasing the fat content, the sugar content increases as well. Use of anhydrous milk fat (or other high dairy fat components) for the standardization overcomes this disadvantage as it has practically zero sugar content. In general, the higher the dairy fat content of the material used for standardization, the easier it is to maintain a lower sugar level.

The processes described herein can deliver a dairy product or beverage which has various fat contents (e.g., 0-5%) and thus can produce a reduced sugar whole, reduced fat, or skim milk product.

Accordingly, a reduced sugar dairy product or beverage can be prepared according to the processes described herein, having levels of fat of greater than or equal to about 0.0%, 0.1%, 0.2%, 0.3%, 0.4%, 0.5%, 1.0%, 1.5%, 2.0%, 2.5%, 3.0%, 3.5%, 4.0%, 4.5%, 5%, and greater, and the like, inclusive of any intermediate values.

Having described the invention in detail, it will be apparent that modifications, variations, and equivalent embodiments are possible without departing from the scope of the invention defined in the appended claims. Furthermore, it should be appreciated that all examples in the present disclosure are provided as non-limiting examples.

### EXAMPLES

The following non-limiting examples are provided to further illustrate embodiments of the invention disclosed herein. It should be appreciated by those of skill in the art that the techniques disclosed in the examples that follow represent approaches that have been found to function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

### Example 1

### Exemplary Implementation—Embodiment 1

2% milk was processed with diafiltration so that the volume of the retentate remained the same. Lactose was steadily removed through the permeate until it reached a concentration of 0.1% w/w in the retentate stream. The concentration of protein and fat remained essentially the same in the final retentate as in the original 2% milk starting material. The concentrations of unbound minerals in the retentate were also reduced through losses in the permeate stream in line with the lactose. Calcium ions which are bound in milk were only slightly reduced in this example. The resulting no-sugar (low-sugar) retentate product was heat treated to pasteurize the product and extend shelf life. In the next step, potassium chloride and sodium chloride were added to the resulting no-sugar (low-sugar) retentate product. The potassium chloride was added to a concentration of 0.115% w/w, and the sodium chloride was added to a concentration of 0.091% w/w to form a final product.

TABLE 2
Chemical analysis of the final product as compared with the original
2% milk.

| | | Original 2% |
|---|---|---|
| | Final Low sugar Product | Milk |
| Ion | (mg/100 g) | (mg/100 g) |
| Sodium | 36 mg | 45 mg |
| Potassium | 60 mg | 150 mg |
| Chlorine | 110 mg | 110 mg |
| Phosphate | Low-below analytical limits | 110 mg |
| Sulfate | Low-below analytical limits | 10 mg |
| Citrate | Low-below analytical limits | 160 mg |
| Bicarbonate | Low-below analytical limits | 10 mg |

The present exemplary implementation exhibited reduced levels of sodium, potassium, phosphate, and citrate for the final low sugar product as compared to standard milk.

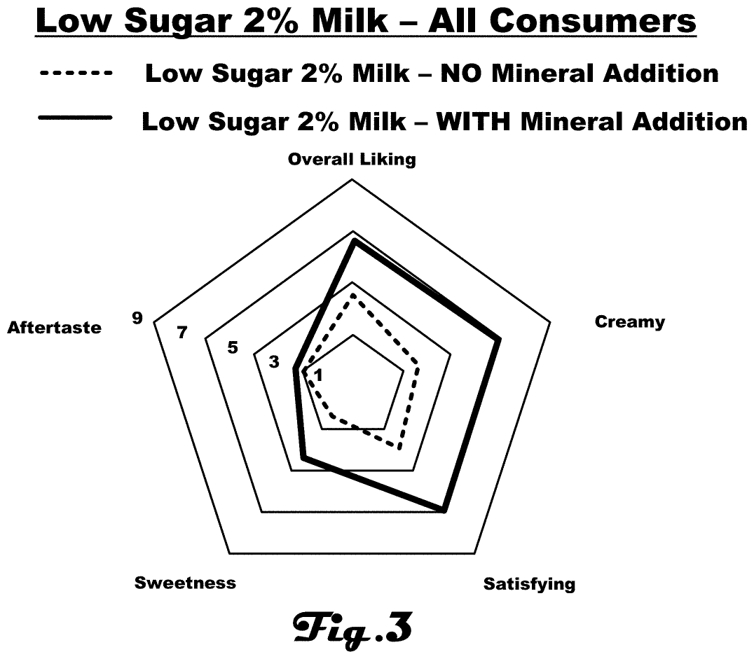

Sensory evaluation with milk consumers showed that the initial low-sugar retentate with no mineral salt additions was described as watery, with a bland taste and lacking in any typical milk taste notes. Surprisingly, after the addition of the potassium and sodium mineral salts to form the final low-sugar product, this product was then described in sensory tests as having a creamier texture and fuller mouthfeel than the initial low-sugar retentate with no mineral salt additions. Indeed, the creamier texture and fuller mouthfeel were closer to the original unprocessed 2% milk. This is especially surprising considering that there is a different composition of minerals (See Table 2 above). The sensory evaluation was also confirmed by consumer testing, where consumers showed a marked preference for the low-sugar product with mineral addition. Consumers also rated the low sugar 2% milk with mineral addition as parity in overall liking compared to standard 2% milk. These results are shown in FIG. 3.

### Example 2

### Exemplary Implementation—Embodiment 2

2% milk was processed with diafiltration so that the volume of the retentate remained the same. Lactose was steadily removed through the permeate until it reached a concentration of 0.16% w/w in the retentate stream. The concentration of protein (3% w/w) and fat (1.8% w/w) remained essentially the same in the final retentate as in the original 2% milk starting material. The concentrations of unbound minerals in the retentate were also reduced through losses in the permeate stream in line with the lactose. Calcium ions which are bound in milk were reduced from 79 mg/100 g to 64 mg/100 g in this example. One portion of the resulting no-sugar (low-sugar) retentate product was heat treated (100 C for 6 secs) to pasteurize the product and extend shelf life, i.e. providing a low-sugar 2% milk without mineral addition. A second portion of the resulting no-sugar (low-sugar) retentate product had a mineral mix of potassium chloride, sodium chloride, and high-acyl gellan gum added to it to deliver the composition in Table 3 below. This mixture was then ultra-pasteurized at 143 C for 4 seconds using direct steam injection and flash cooling, i.e. providing a low-sugar 2% milk with mineral addition.

TABLE 3
Composition of reduced sugar dairy products with and without
mineral addition.

| | Low-sugar 2% milk | Low-sugar 2% milk |
|---|---|---|
| Component | without mineral addition | with mineral addition |
| Protein | 2.97% (w/w) | 2.98% (w/w) |
| Fat | 1.89% (w/w) | 1.81% (w/w) |
| Lactose | 0.2% (w/w) | 0.16% (w/w) |
| | (estimate) | |
| Potassium | 6 mg/100 g | 50 mg/100 g |
| Sodium | 2 mg/100 g | 31 mg/100 g |
| Calcium | 79 mg/100 g | 64 mg/100 g |
| Gellan Gum | 0 | 0.03% (w/w) |

Both products were presented blind to dairy consumers (n=109) in a Central Location Test carried out over 2 days in the greater Chicago area.

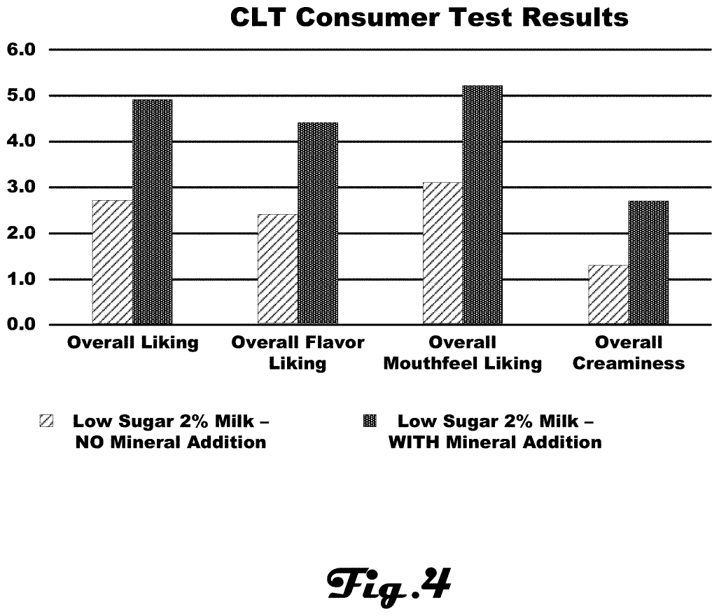

FIG. 4 illustrates these results, which clearly show that the added mineral combination improves the consumer acceptance of the low-sugar dairy product. In some embodiments, the low-sugar fat reduced 2% milk with mineral addition scored on parity with conventional fat reduced 2% milk.

### Example 3

### Exemplary Implementation—Embodiment 3

Skimmed milk was processed with diafiltration. In this case, the resulting retentate was concentrated to approximately twice the protein content (6.8%) of the incoming milk. Lactose was steadily removed through the permeate until it reached a concentration of around 0.1% w/w in the retentate stream. Cream (at 45% fat) was then added to the retentate to achieve a final fat content of 3.4% The resulting low-sugar UF concentrate had the composition shown in the table below. The low-sugar UF concentrate was then transferred to a batching system where water and a mineral mix of sodium chloride, potassium chloride, dipotassium phosphate, tricalcium phosphate, and high acyl gellan gum were added to achieve the composition concentration in the table (low-sugar UF finished product) and according to the recipe shown in Table 4 below.

TABLE 4
Recipe for production of a sugar-free reduced fat milk product from
a low sugar UF concentrate.

| Ingredient | % Addition |
|---|---|
| Low sugar UF concentrate | 55.0% |
| Water | 46.6% |
| Sodium chloride | 0.1% |
| Potassium chloride | 0.1% |
| Dipotassium phosphate | 0.1% |
| Tricalcium phosphate | 0.1% |
| Vitamins A & D* | Insignificant amount |

*Vitamins A & D were added as a blend to deliver a level in the finished product of at least 150 mcg and 2.5 mcg/240 ml per serving, respectively.

The resulting low-sugar blend was then ultra-pasteurized through a Tetra-Laval VTIS heat treatment unit with direct steam injection and flash cooling. Ultra-pasteurization was at 141 C for 2 seconds with post holding tube homogenization at 2200 psi. The product was then cooled to 3 C and transferred to a sterile holding tank after which it was fed to an Extended Shelf-Life carton filler and subsequent refrigerated storage. The resulting product was found to have a clean taste with no off-flavors and a good satisfying mouthfeel close to standard 2% milk. Under shelf life testing over 90 days the product did not noticeably degrade or form a gel precipitate. Zahn (#2) cup viscosity at 7 C was 21 seconds comparable with a standard whole standard milk at 15 secs at the same temperature and constant pressure. These results are shown in Table 5 below.

TABLE 5
Composition of low sugar UF concentrate and the sugar-free
reduced fat milk product made according to the recipe in Table 4.

| | Low sugar UF | Low sugar finished |
|---|---|---|
| Component | concentrate | product |
| Protein | 7.14% (w/w) | 3.64% (w/w) |
| Fat | 3.41% (w/w) | 1.71% (w/w) |
| Lactose | 0.28% (w/w) | 0.17% (w/w) |
| Calcium | 150 mg/100 g | 102 mg/100 g |
| Potassium | 21 mg/100 g | 66 mg/100 g |
| Sodium | 5 mg/100 g | 41 mg/100 g |

### Example 4

### Exemplary Implementation—Embodiment 4

Home tests with a reduced free, reduced fat milk product produced according to the processes described herein showed the product could be used on cereal (an important use of milk), as well as in tea or coffee and in cooking. The product could be foamed by whipping in air or through injecting steam for use in such coffee products as lattes and cappuccinos. Indeed, it has been shown that sugar-free milk products have superior foaming characteristics when compared to the corresponding milks (see table below). This high foaming tendency may be considered a positive aspect for the preparation of foamed beverages.

TABLE 6
Products foamed by shearing 50 ml at 12 C. for 15 seconds and then
poured immediately into a measuring cylinder to measure volume.

| | Volume Un- | Volume | |
|---|---|---|---|
| Sample | foamed (ml) | Foamed (ml) | Overrun |
| Fat-free pasteurized milk | 50 | 86 | 72% |
| Fat-free pasteurized sugar-free | 50 | 110 | 120% |
| milk with KCl (70 mg K/100 g) | | | |
| and Gellan gum (0.03%) | | | |
| Fat reduced ultra-pasteurized | 50 | 65 | 30% |
| milk | | | |
| Fat reduced ultra-pasteurized | 50 | 115 | 130% |
| milk (as described 0042) | | | |

### Example 5

### Exemplary Implementation—Embodiment 5

In one embodiment, dipotassium phosphate with sodium chloride was added to the sugar-free (or low-sugar) dairy base at a level so that the final potassium level was in the region of 60-65 mg/100 g in the product, and the resulting product ultra-pasteurized (direct steam injection with holding at 139CF for 2 sec). When freshly prepared, this product also produced a noticeable increase in perceived mouthfeel as compared to the sugar-free (or low-sugar) dairy base without any additions; however, the increased change in mouthfeel was not as pronounced as for potassium chloride at similar final potassium levels.

In a further embodiment, a sugar-free UF fat free milk was prepared from a diafiltered product. In sample ZSM-0, there was no mineral addition; in samples ZSM-70 and ZSM-140, potassium chloride was added to achieve potassium concentrations of approximately 70 mg/100 g and 140 mg/100 g respectively; and in ZSM-P70, dipotassium phosphate was added to achieve a potassium concentration of approximately 70 mg/100 g (see compositions in Table 7). The products where then pasteurized at 72 C for 15 secs and cooled to below 8 C and held for 2 days before being presented blind to a trained sensory panel for a quantitative descriptive analysis (Curion QDA®).

TABLE 7
Composition of sugar-free diafiltered fat free milk preparations for
sensory quantitative descriptive analysis (QDA).

| Product | | Protein % | Fat % | Lactose % | Potassium | Sodium |
|---|---|---|---|---|---|---|
| Code | Description | (w/w) | (w/w) | (w/w) | (mg/100 g) | (mg/100 g) |
| ZSM-0 | Sugar Free diafiltered, | 3.07 | <0.1 | 0.14 | 7.83 | <5.00 |
| | fat free milk | | | | | |
| | preparation. No | | | | | |
| | additions | | | | | |
| ZSM-70 | ZSM-0 plus potassium | 3.66 | <0.1 | 0.14 | 75.1 | <5.00 |
| | chloride to apx 70 mg | | | | | |
| | potassium/100 g | | | | | |
| ZSM-140 | ZSM-0 plus potassium | 3.50 | <0.1 | 0.14 | 133 | <5.00 |
| | chloride to apx 140 mg | | | | | |
| | potassium/100 g | | | | | |
| ZSM-P70 | ZSM-0 plus | 3.25 | <0.1 | 0.14 | 70.2 | <5.00 |
| | Dipotassium | | | | | |
| | Phosphate to apx | | | | | |
| | 70 mg potassium/100 g | | | | | |

The results show that the addition of potassium chloride to the sugar-free UF fat free milk changes the perceived mouthfeel and other flavor attributes. This effect is seen at the 70 mg/100 g level and more so at 140 mg/100 g (but not double). However, the addition of dipotassium phosphate also changes perceived mouthfeel and other flavor attributes, but in the opposite direction to potassium chloride so that some attributes are lower than for the sugar-free UF fat free milk without any additions. The results for key attributes are shown in Table 8 and show the surprising impact of potassium chloride on attributes related to mouthfeel and dairy flavor in a sugar-free milk preparation. These effects are noticeable to the consumer (as opposed to a trained panel) in other sugar-free milk preparations and furthermore impact overall liking. See, for example, FIGS. 3 and 4.

TABLE 8
Quantitative sensory scores for key attributes. 60 point scale. Different
letters denote significant differences at 90% confidence limits.

| Product/Attribute | ZSM-0 | ZSM-70 | ZSM-140 | ZSM-P70 |
|---|---|---|---|---|
| Mouthfeel-thickness | 13.6_{B} | 18.6_{AB} | 19.6_{A} | 7.6_{C} |
| Mouthfeel-creamy | 12.7_{B} | 16.1_{AB} | 20.0_{A} | 6.3_{C} |
| Flavor-Milk/Dairy | 13.4_{C} | 24.0_{B} | 29.6_{A} | 7.5_{D} |
| Flavor-Fresh | 16.4_{AB} | 20.4_{A} | 22.2_{A} | 11.2_{B} |
| Aftertaste-Milk Dairy | 12.0_{B} | 19.0_{A} | 22.2_{A} | 6.2_{C} |

### Example 6

### Exemplary Implementation—Embodiment 6

It is known that sugar-free UF retentate can be concentrated and dried to form a powder generally referred to as milk protein isolate (MPI, sometimes also referred to as milk protein concentrate). This provides another route to make a low sugar dairy product by taking the powder and simply adding water. Such a product was also found to be thin and lacking mouthfeel and with caramel notes and off-tastes (presumably from the drying process). The mouthfeel of the product can also be improved by the addition of potassium chloride. Although this method can be more costly (because of the drying) and potentially lower quality due to the impact of drying, it does offer an opportunity to store the low sugar milk component over an extended period prior to reconstitution with water, mineral addition, and subsequent pasteurization/ultra-pasteurization and filling. Alternatively, the MPI powder can be used to supplement the exiting protein level in the low-sugar product without significantly increasing the lactose/sugar level.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the invention extend beyond the specifically disclosed embodiments to other alternative embodiments and/or uses and modifications and equivalents thereof.

In some embodiments, the numbers expressing quantities of ingredients, properties such as molecular weight, reaction conditions, and so forth, used to describe and claim certain embodiments of the application are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Preferred embodiments of this application are described herein. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the invention. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

What is claimed is:

1. A reduced sugar dairy product with an improved mouthfeel, comprising:
dairy protein in an amount of 0.1%-12%;
sugar in an amount of less than 5.0%; and
minerals in an amount of 20 mg to 400 mg, or greater per 100 g of the reduced sugar dairy product;
butter fat in an amount of 0%-36%; and
wherein the reduced sugar dairy product is derived from milk.

2. The reduced sugar dairy product of claim 1, comprising:
dairy protein in an amount of 0.1%-12%;
sugar in an amount of less than 1.2%;
potassium in an amount of range 20%-400%; and
butter fat in an amount of 0%-36%.

3. The reduced sugar dairy product of claim 1, wherein the reduced sugar dairy product is a beverage, a concentrate, or a powder.

4. The reduced sugar dairy product of claim 1, comprising lactose in an amount of less than 5.0%.

5. The reduced sugar dairy product of claim 1, wherein the reduced sugar dairy product is a beverage and has less than about 5.0 g, 4.0 g, 3.0 g, 2.0 g, 1.0 g, 0.9 g, 0.8 g, 0.7 g, 0.6 g, 0.5 g, 0.4 g, 0.3 g, 0.2 g, 0.1 g, 0.09 g, 0.08 g, 0.07 g, 0.06 g, 0.05 g, 0.04 g, 0.03 g, 0.02 g, 0.01 g of sugar in an 240 ml serving.

6. The reduced sugar dairy product of claim 1, wherein the reduced sugar dairy product is a beverage and is about or below about 5.0%, 4.0%, 3.0%, 2.0%, 1.0%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01% w/w sugar.

7. The reduced sugar dairy product of claim 1, wherein the reduced sugar dairy product has an increased or reduced protein level relative to that of untreated milk.

8. The reduced sugar dairy product of claim 7, wherein the reduced sugar dairy product has an increased protein level of greater than or equal to about 3.0%, 3.5%, 4.0%, 4.5%, 5%, 5.5%, 6.0%, 6.5%, 7.0%, 7.5%, 8.0%, 8.5%, 9.0%, 9.5%, 10.0%, 11.0%, or 12.0% w/w.

9. The reduced sugar dairy product of claim 7, wherein the reduced sugar dairy product has a reduced protein level of less than or equal to about 3.0%, 2.5%, 2.0%, 1.5%, 1.0%, 0.5%, 0.4%, 0.3%, 0.2%, 0.1%, 0.05% w/w.

10. The reduced sugar dairy product of claim 1, wherein the reduced sugar dairy product further comprises a lactase enzyme.

11. The reduced sugar dairy product of claim 1, wherein the reduced sugar dairy product further comprises one or more mineral salts.

12. The reduced sugar dairy product of claim 11, wherein the reduced sugar dairy product further comprises one or more potassium salts.

13. The reduced sugar dairy product of claim 12, wherein the reduced sugar dairy product further comprises one or more potassium salts at a level of greater than or equal to about 20 mg, 25 mg, 50 mg, 75 mg, 100 mg, 125 mg, 150 mg, 175 mg, 200 mg, 225 mg, 250 mg, 275 mg, 300 mg, 325 mg, 350 mg, 375 mg, 400 mg, or greater of potassium per 100 g of the reduced sugar dairy product.

14. The reduced sugar dairy product of claim 12, wherein the potassium salt comprises potassium chloride.

15. The reduced sugar dairy product of claim 12, wherein the potassium salt comprises dipotassium phosphate, monopotassium phosphate, and/or tripotassium phosphate.

16. The reduced sugar dairy product of claim 12, wherein the potassium salt comprises two or more of potassium chloride, dipotassium phosphate, monopotassium phosphate, and/or tripotassium phosphate.

17. The reduced sugar dairy product of claim 11, wherein the reduced sugar dairy product further comprises one or more additional alkali metal or alkali earth metal salts.

18. The reduced sugar dairy product of claim 17, wherein the reduced sugar dairy product further comprises one or more sodium, lithium, calcium, and/or magnesium salts.

19. The reduced sugar dairy product of claim 17, wherein the reduced sugar dairy product comprises potassium chloride and sodium chloride.

20. The reduced sugar dairy product of claim 1, wherein the reduced sugar dairy product further comprises one or more bitter blockers.

21. The reduced sugar dairy product of claim 1, wherein the reduced sugar dairy product is a beverage and has a fat level of than or equal to about 0.0%, 0.1%, 0.2%, 0.3%, 0.4%, 0.5%, 1.0%, 1.5%, 2.0%, 2.5%, 3.0%, 3.5%, 4.0%, 4.5%, 5%, or greater.

22. The reduced sugar dairy product of claim 1, wherein the reduced sugar dairy product further comprises one or more thickening agent.

23. The reduced sugar dairy product of claim 22, wherein the thickening agent comprises gellan gum.

24. The reduced sugar dairy product of claim 23, wherein the gellan gum is at a level of about 0.01%-0.10%.

25. The reduced sugar dairy product of claim 23, wherein the reduced sugar dairy product comprises potassium chloride, sodium chloride, and gellan gum.

26. The reduced sugar dairy product of claim 25, wherein the reduced sugar dairy product comprises potassium chloride at a level of 20%-200% of potassium levels in retail fat reduced milk, sodium chloride at a level of 10%-200% of sodium levels in retail fat reduced milk, and 0.01-0.10% gellan gum.

27. The reduced sugar dairy product of claim 1, wherein the reduced sugar dairy product further comprises one or more fats and/or alternative fats.

28. The reduced sugar dairy product of claim 27, wherein the fat comprises cream and/or wherein the alternative fat comprises canola oil, palm oil, coconut oil, and/or medium chain triglycerides (MCT).

29. The reduced sugar dairy product of claim 1, wherein the reduced sugar dairy product has the protein level of untreated bovine milk.

30. The reduced sugar dairy product of claim 29, wherein the reduced sugar dairy product comprises 2.9%-5.0% protein, 3.6%-5.5% lactose, 2.5%-6.0% fat, and 0.6%-0.9% minerals.

31. The reduced sugar dairy product of claim 1, wherein the reduced sugar dairy product has the protein level of conventional pasteurized retail milk.

32. The reduced sugar dairy product of claim 31, wherein the reduced sugar dairy product comprises 2.9%-3.5% protein, 3.6%-5.5% lactose, 2.5%-6.0% fat, and 0.6%-0.9% minerals.

33. The reduced sugar dairy product of claim 1, wherein the reduced sugar dairy product has the protein level of conventional pasteurized retail skim milk.

34. The reduced sugar dairy product of claim 33, wherein the reduced sugar dairy product comprises 3.2%-3.5% protein, 3.6%-5.5% lactose, 0%-3.0% fat, and 0.6%-0.9% minerals.

35. The reduced sugar dairy product of claim 1, wherein the reduced sugar dairy product comprises less than 0.5 mg, 1 mg, 5 mg, 10 mg, 15 mg, 20 mg, 25 mg, 30 mg, or greater, sodium per 100 g.

36. The reduced sugar dairy product of claim 1, wherein the reduced sugar dairy product is pasteurized, ultra-pasteurized, and/or sterilized.

37. The reduced sugar dairy product of claim 1, wherein the reduced sugar dairy product the product has a shelf life of greater than 14 days, greater than 28 days, greater than 1 month, greater than 2 months, or greater than 3 months.

38. The reduced sugar dairy product of claim 1, wherein the reduced sugar dairy product is a reduced sugar whole milk beverage, a reduced sugar and reduced fat milk beverage, or a reduced sugar skim milk beverage.

39. The reduced sugar dairy product of claim 1, wherein the reduced sugar dairy product further comprises one or more non-nutritive sweetener.

40. The reduced sugar dairy product of claim 39, wherein the non-nutritive sweetener comprises one or more of stevia, monk fruit, D-allulose, acesulfame potassium, sucralose, erythritol, xylitol, sorbitol, lactitol, aspartame, saccharin, cyclamate, neotame, and/or advantame.

41. The reduced sugar dairy product of claim 1, wherein the reduced sugar dairy product further comprises a natural or artificial flavoring, to provide a flavored dairy beverage.

42. The reduced sugar dairy product of claim 41, wherein the natural or artificial flavoring comprises a coffee, cocoa, chai, berry, vanilla, coconut, and/or banana flavoring.

43. The reduced sugar dairy product of claim 41, wherein the reduced sugar dairy product is a chocolate milk beverage.

44. The reduced sugar dairy product of claim 1, wherein the reduced sugar dairy product is derived from cow, sheep, goat, buffalo, or camel milk.

45. The reduced sugar dairy product of claim 44, wherein the reduced sugar dairy product is derived from cow milk.

46. The reduced sugar dairy product of claim 1, wherein the reduced sugar dairy product is a powder comprising potassium in a level of about 20 mg-400 mg 100 g of the sugar-free (or low-sugar) dairy.

47. A composition comprising the reduced sugar dairy product of claim 1 and another food or beverage component.

48. The composition of claim 47, wherein the composition is a sports drink or a coffee- or tea-based beverage.

49. The composition of claim 47, wherein the composition is a dairy dessert.

50. The composition of claim 49, wherein the composition is an ice cream.

51. A method for providing a reduced sugar dairy product, the method comprising:
a. pumping a first volume of a dairy product from a first filtration tank through a first ultra-filtration unit into a collection tank, to provide a first retentate and a first permeate;
b. providing the first retentate to a subsequent filtration tank, which is the same or different from the first filtration tank;
c. adding a volume of water into the subsequent filtration tank containing the first retentate, to reach a second volume in the subsequent filtration tank;
d. pumping the second volume, comprising the first retentate and water, from the subsequent filtration tank through a subsequent ultra-filtration unit, which is the same or different from the first ultra-filtration unit, to provide a subsequent retentate and a subsequent permeate; and
e. repeating steps of returning retentate to a subsequent filtration tank, which is the same or different from any previous filtration tank, adding water to reach a volume in the subsequent filtration tank, and pumping the volume through a subsequent ultra-filtration unit, which is the same or different from any previous ultra-filtration unit, to provide a new retentate and a new permeate, n times, where n is an integer between 0 and 30, wherein the new retentate provides a reduced sugar dairy product; and
wherein the method removes at least 25% of the sugar present in the dairy product.

52. The method of claim 51, wherein the method removes at least 50%, 80%, 85%, 90%, 91%, 92%, 93%, 94%, 95%, 96%, 97%, 98%, 99%, or greater of the sugar present in the dairy product.

53. The method of claim 51, wherein the dairy product is raw or pasteurized prior to undergoing any ultra-filtration step.

54. The method of claim 51, wherein the volume of water added is sufficient to bring the volume of the any filtration tank prior to any ultra-filtration step to that of the first volume of raw dairy product.

55. The method of claim 51, wherein a lactase enzyme is added to the dairy product prior to any ultra-filtration step.

56. The method of claim 51, wherein the process is a continuous process.

57. The method of claim 51, wherein a mineral salt and/or a naturally occurring salt is added after step e.

58. The method of claim 57, wherein the mineral salt comprises one or more potassium salts at a level of greater than or equal to about 20 mg, 25 mg, 50 mg, 75 mg, 100 mg, 125 mg, 150 mg, 175 mg, 200 mg, 225 mg, 250 mg, 275 mg, 300 mg, 325 mg, 350 mg, 375 mg, 400 mg, or greater of potassium per 100 g of the reduced sugar dairy product.

59. The method of claim 58, wherein the potassium salt comprises potassium chloride.

60. The method of claim 58, wherein the potassium salt comprises dipotassium phosphate, monopotassium phosphate, and/or tripotassium phosphate.

61. The method of claim 58, wherein the potassium salt comprises two or more of potassium chloride, dipotassium phosphate, monopotassium phosphate, and/or tripotassium phosphate.

62. The method of claim 57, wherein the reduced sugar dairy product further comprises one or more additional alkali metal or alkali earth metal salts.

63. The method of claim 62, wherein the reduced sugar dairy product further comprises one or more sodium, lithium, calcium, and/or magnesium salts.

64. The method of claim 62, wherein the reduced sugar dairy product comprises potassium chloride and sodium chloride.

65. The method of claim 51, wherein one or more thickening agent is added after step e.

66. The method of claim 65, wherein the thickening agent comprises gellan gum.

67. The method of claim 51, wherein one or more fats and/or alternative fats is added before, during, or after any method step.

68. The method of claim 67, wherein the fat comprises cream and/or anhydrous milk fat and/or wherein the alternative fat comprises canola oil, palm oil, coconut oil, or medium chain triglyceride (MCT).

69. The method of claim 51, wherein the reduced sugar dairy product has the protein level of untreated bovine milk.

70. The method of claim 69, wherein the reduced sugar dairy product comprises 2.9%-5.0% protein, 3.6%-5.5% lactose, 2.5%-6.0% fat, and 0.6%-0.9% minerals.

71. The method of claim 51, wherein the reduced sugar dairy product has the protein level of conventional pasteurized retail milk.

72. The method of claim 71, wherein the reduced sugar dairy product comprises 2.9%-3.5% protein, 3.6%-5.5% lactose, 2.5%-6.0% fat, and 0.6%-0.9% minerals.

73. The method of claim 51, wherein the reduced sugar dairy product has the protein level of conventional pasteurized retail skim milk.

74. The method of claim 73, wherein the reduced sugar dairy product comprises 3.2%-3.5% protein, 3.6%-5.5% lactose, 0%-3.0% fat, and 0.6%-0.9% minerals.

75. The method of claim 51, the method further comprises heat treatment and/or high pressure processing (HPP) following step e.

76. The method of claim 75, wherein the heat treatment and/or HPP is used to pasteurize, ultra-pasteurize, or sterilize the product.

77. The method of claim 75, wherein the heat treatment is conducted at a temperature between about 63-100 C.

78. The method of claim 75, wherein one or more potassium and/or sodium salt is added and wherein the heat treatment is conducted at a temperature between about 63-150 C.

79. The method of claim 51, wherein the dairy product is subject to one or more pre-processing steps.

80. The method of claim 79, wherein the pre-processing steps comprise pasteurization and/or standardization.

81. A method for providing a reduced sugar dairy product, the method comprising:
a. pumping a first volume of a dairy product from a first filtration tank through a first ultra-filtration unit, to provide a first retentate and a first permeate;
b. injecting a volume of water to provide a diluted retentate;
c. pumping the diluted rententate through a subsequent ultra-filtration unit, which is the same or different from the first ultra-filtration unit, to provide a subsequent retentate and a subsequent permeate; and
d. repeating steps of injecting a volume of water to provide a diluted retentate, and pumping the diluted retentate through a subsequent ultra-filtration unit, which is the same or different from any previous ultra-filtration unit, to provide a new retentate and a new permeate, n times, where n is an integer between 0 and 30, wherein the new retentate comprises a reduced sugar dairy product; and
wherein the method removes at least 25% of the sugar present in the dairy product.

82. The method of claim 81, wherein the method removes at least 50%, 80%, 85%, 90%, 91%, 92%, 93%, 94%, 95%, 96%, 97%, 98%, 99%, or greater of the sugar present in the dairy product.

83. The method of claim 81, wherein the dairy product is raw or pasteurized prior to undergoing any ultra-filtration step.

84. The method of claim 81, wherein the volume of water added is sufficient to bring the volume of the any filtration tank prior to any ultra-filtration step to that of the first volume of raw dairy product.

85. The method of claim 81, wherein a lactase enzyme is added to the dairy product prior to any ultra-filtration step.

86. The method of claim 81, wherein the process is a continuous process.

87. The method of claim 81, wherein a mineral salt and/or a naturally occurring salt is added after obtaining a new retentate.

88. The method of claim 87, wherein the mineral salt comprises one or more potassium salts at a level of greater than or equal to about 20 mg, 25 mg, 50 mg, 75 mg, 100 mg, 125 mg, 150 mg, 175 mg, 200 mg, 225 mg, 250 mg, 275 mg, 300 mg, 325 mg, 350 mg, 375 mg, 400 mg, or greater of potassium per 100 g of the reduced sugar dairy product.

89. The method of claim 88, wherein the potassium salt comprises potassium chloride.

90. The method of claim 88, wherein the potassium salt comprises dipotassium phosphate, monopotassium phosphate, and/or tripotassium phosphate.

91. The method of claim 88, wherein the potassium salt comprises two or more of potassium chloride, dipotassium phosphate, monopotassium phosphate, and/or tripotassium phosphate.

92. The method of claim 87, wherein the reduced sugar dairy product further comprises one or more additional alkali metal or alkali earth metal salts.

93. The method of claim 92, wherein the reduced sugar dairy product further comprises one or more sodium, lithium, calcium, and/or magnesium salts.

94. The method of claim 92, wherein the reduced sugar dairy product comprises potassium chloride and sodium chloride.

95. The method of claim 81, wherein one or more thickening agent is added after obtaining a new retentate.

96. The method of claim 95, wherein the thickening agent comprises gellan gum.

97. The method of claim 81, wherein one or more fats and/or alternative fats is added before, during, or after any method step.

98. The method of claim 97, wherein the fat comprises cream and/or anhydrous milk fat and/or wherein the alternative fat comprises canola oil, palm oil, coconut oil, or medium chain triglyceride (MCT).

99. The method of claim 81, wherein the reduced sugar dairy product has the protein level of untreated bovine milk.

100. The method of claim 99, wherein the reduced sugar dairy product comprises 2.9%-5.0% protein, 3.6%-5.5% lactose, 2.5%-6.0% fat, and 0.6%-0.9% minerals.

101. The method of claim 81, wherein the reduced sugar dairy product has the protein level of conventional pasteurized retail milk.

102. The method of claim 101, wherein the reduced sugar dairy product comprises 2.9%-3.5% protein, 3.6%-5.5% lactose, 2.5%-6.0% fat, and 0.6%-0.9% minerals.

103. The method of claim 81, wherein the reduced sugar dairy product has the protein level of conventional pasteurized retail skim milk.

104. The method of claim 103, wherein the reduced sugar dairy product comprises 3.2%-3.5% protein, 3.6%-5.5% lactose, 0%-3.0% fat, and 0.6%-0.9% minerals.

105. The method of claim 81, the method further comprises heat treatment and/or high pressure processing (HPP) after obtaining a new retentate.

106. The method of claim 105, wherein the heat treatment and/or HPP is used to pasteurize, ultra-pasteurize, or sterilize the product.

107. The method of claim 105, wherein the heat treatment is conducted at a temperature between about 63-100 C.

108. The method of claim 105, wherein one or more potassium and/or sodium salt is added and wherein the heat treatment is conducted at a temperature between about 63-150 C.

109. The method of claim 81, wherein the dairy product is subject to one or more pre-processing steps.

110. The method of claim 109, wherein the pre-processing steps comprise pasteurization and/or standardization.
